(19) United States
(12) Patent Application Publication
(10) Pub. No.: US 2017/0169042 A1
(43) Pub. Date: Jun. 15, 2017

(54) WEBPAGE DISPLAY METHOD, MOBILE TERMINAL, INTELLIGENT TERMINAL, COMPUTER PROGRAM AND STORAGE MEDIUM

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Zhen LI, Beijing (CN)

(73) Assignees: LE HOLDINGS (BEIJING) CO., LTD., Beijing (CN); LE SHI ZHI XIN ELECTRONIC TECHNOLOGY (TIANJIN) LIMITED, Beijing (CN)

(21) Appl. No.: 15/246,506

(22) Filed: Aug. 24, 2016

Related U.S. Application Data
(63) Continuation of application No. PCT/CN2016/088618, filed on Jul. 5, 2016.

(30) Foreign Application Priority Data
Dec. 10, 2015 (CN) 201510925784.3

(51) Int. Cl. G06F 17/30; G06F 3/0482; H04L 29/08; G06F 3/0488

(52) U.S. Cl. CPC G06F 17/3089; G06F 17/30879; G06F 3/0488; G06F 3/0482; H04L 67/02

(57) ABSTRACT

The present disclosure provides a webpage display method based on a link identifier, a non-transitory computer-readable storage medium, another webpage display method based on a link identifier and another non-transitory computer-readable storage medium, and relates to the technical field of communications. In the present disclosure, the webpage display method based on a link identifier includes sending a webpage list request to an intelligent terminal according to a link identifier, receiving and displaying a webpage list corresponding to the webpage list request sent by the intelligent terminal, detecting an instruction input by a user on the webpage list and determining a webpage address of a webpage to be browsed according to the instruction, and sending the webpage address of the webpage to be browsed to the intelligent terminal, allowing the intelligent terminal to display the webpage to be browsed corresponding to the webpage address of the webpage to be browsed.

### CROSS-REFERENCE TO RELATED APPLICATIONS

The present disclosure is a continuation of International Application No. PCT/CN2016/088618, filed on Jul. 5, 2016, which is based upon and claims priority to Chinese Patent Application No. 201510925784.3, filed on Dec. 10, 2015, the entire contents of which are incorporated herein by reference.

### TECHNICAL FIELD

The present disclosure relates to the field of video image processing technology, and in particular, to webpage display methods based on link identifier, and non-transitory computer-readable storage mediums.

### BACKGROUND

With the development of technology, an intelligent terminal (such as a smart TV and other devices) is also more and more intelligent. A user can complete a lot of demands on the intelligent terminal, for example, browsing a webpage on the intelligent terminal;

In a process of implementing the present disclosure, the inventor finds that the prior art at least has the following problems: when browsing the webpage on the intelligent terminal, the operation is carried out by a remote controller in general. Whenever browser operation or texts input is done by a remote control, the problem of operation inconvenience appears, which results in a low user experience.

### SUMMARY

The object of the present disclosure is to provide a webpage display method based on a link identifier, a non-transitory computer-readable storage medium, another webpage display method based on a link identifier and another non-transitory computer-readable storage medium, in order to solve or at least partially solve the problem that operation inconvenience in the prior art results in lower user experience.

On a first aspect, the embodiments of the present disclosure provide a webpage display method based on a link identifier, including:

sending a webpage list request to an intelligent terminal according to a link identifier, wherein the link identifier is generated based on the address of the intelligent terminal;

receiving and displaying a webpage list corresponding to the webpage list request sent by the intelligent terminal;

detecting an instruction input by a user on the webpage list and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

On another aspect, the embodiments of the present disclosure further provide a non-transitory computer-readable storage medium, storing executable instructions that, when executed by an electronic device with a touch-sensitive display, cause the electronic device to:

send a webpage list request to an intelligent terminal according to a link identifier, wherein the link identifier is generated based on the address of the intelligent terminal;

receive and display a webpage list corresponding to the webpage list request sent by the intelligent terminal;

detect an instruction input by a user on the webpage list and determining a webpage address of a webpage to be browsed according to the instruction; and

send the webpage address of the webpage to be browsed to the intelligent terminal, and allow the intelligent terminal to display the webpage to be browsed corresponding to the webpage address of the webpage to be browsed.

On another aspect, the embodiments of the present disclosure further provide a webpage display method based on a link identifier, including:

when receiving a webpage list request sent by a mobile terminal according to the link identifier, sending a webpage list corresponding to the webpage list request to the mobile terminal, wherein the link identifier is generated based on the address of the intelligent terminal;

receiving a webpage address of a webpage to be browsed sent by the mobile terminal, wherein the webpage address of the webpage to be browsed is determined by an instruction input by a user on the webpage list; and

obtaining the webpage to be browsed based on the webpage address of the webpage to be browsed, and displaying the webpage to be browsed.

On another aspect, the embodiments of the present disclosure further provide a non-transitory computer-readable storage medium storing executable instructions that, when executed by an electronic device with a touch-sensitive display, cause the electronic device to:

when receive a webpage list request sent by a mobile terminal according to the link identifier, send a webpage list corresponding to the webpage list request to the mobile terminal, wherein the link identifier is generated based on the address of the intelligent terminal;

receive a webpage address of a webpage to be browsed sent by the mobile terminal, wherein the webpage address of the webpage to be browsed is determined by an instruction input by a user on the webpage list; and

obtain the webpage to be browsed based on the webpage address of the webpage to be browsed, and displaying the webpage to be browsed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a webpage display method based on a link identifier provided by some embodiments of the present disclosure;

FIG. 2 is a flowchart of a webpage display method based on a link identifier provided by some embodiments of the present disclosure;

FIG. 3 is a flowchart of a webpage display method based on a link identifier provided by some embodiments of the present disclosure;

FIG. 4 is a flowchart of a webpage display method based on a link identifier provided by some embodiments of the present disclosure;

FIG. 5 is a structural block diagram of a mobile terminal provided by some embodiments of the present disclosure;

FIG. 6 is a structural block diagram of an intelligent terminal provided by some embodiments of the present disclosure.

### DETAILED DESCRIPTION

In order that the objects, technical solutions and advantages of the present disclosure are clearer, a clear and complete description of technical solutions in the embodiments of the present disclosure will be given below, in combination with the accompanying drawings in the embodiments of the present disclosure. Apparently, the embodiments described below are merely a part, but not all, of the embodiments of the present disclosure. All of other embodiments, obtained by those of ordinary skill in the art based on the embodiments of the present disclosure without any creative effort, fall into the protection scope of the present disclosure.

In order to solve the problem in the prior that the operation of browsing a webpage on an intelligent terminal by a remote controller is inconvenient to result in lower user experience, in the embodiments of the present disclosure, a mobile terminal sends a webpage list request to an intelligent terminal according to a link identifier, receives and displays a webpage list corresponding to the webpage list request sent by the intelligent terminal, detects an instruction input by a user on the webpage list, determines a webpage address of a webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

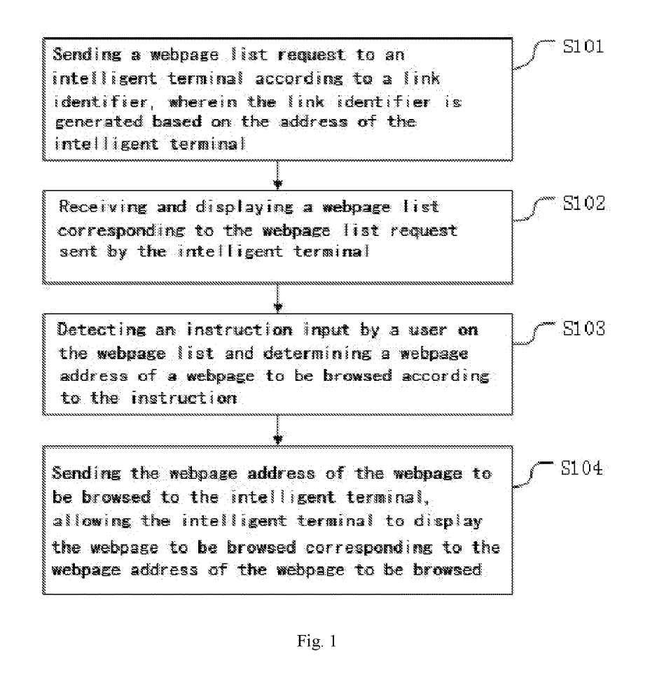

The embodiments of the present disclosure are used in a scenario in which the user operates on the mobile terminal to display the webpage to be browsed on the intelligent terminal. FIG. 1 is a flowchart of a webpage display method based on a link identifier provided by one embodiment of the present disclosure. Refer to FIG. 1, the method includes:

S101: a webpage list request is sent to an intelligent terminal according to a link identifier, wherein the link identifier is generated based on the address of the intelligent terminal; and

it should be noted that the webpage list request is sent to the intelligent terminal according to the link identifier in a variety of manners, in order to conveniently send the webpage list request to the intelligent terminal, in the embodiment, the link identifier is scanned to send the webpage list request to the intelligent terminal, of course, the webpage list request can also be sent to the intelligent terminal in other manners, and this is not limited in the embodiment.

It can be understood that an executive body of the method in the embodiment is the mobile terminal, the mobile terminal is a mobile phone, a tablet computer, a palm computer PDA or a notebook computer and other terminal devices with similar functions, and this is not limited in the embodiment of the present disclosure.

In specific implementation, the link identifier can be a QR code, a barcode and other identifiers displayed on a display interface of the intelligent terminal, so the link identifier can be stored in the intelligent terminal, and furthermore, for the consideration of the space utilization rate and other requirements during the display on the display interface of the intelligent terminal, the link identifier is optionally the QR code.

The address of the intelligent terminal is an address that can be used for positioning the location of the intelligent terminal, for example, an IP address or an MAC address or the like, and this is not limited in the embodiment.

S102: a webpage list corresponding to the webpage list request sent by the intelligent terminal is received and displayed; and

in specific implementation, the webpage list includes webpage addresses of a plurality of webpages, the webpage addresses are entry addresses linking the webpages, for example, a uniform resource locator (URL), an IP address or an MAC address or the like, and this is not limited in the embodiment.

To conveniently guide the operation of the user, the webpages in the webpage list are generally common webpages and can be collected in a network by a web crawler and other tools, for example, common video webpages and news webpages or the like, of course, the webpages of other types can also be included, and this is not limited in the embodiment.

S103: an instruction input by a user on the webpage list is detected, and a webpage address of a webpage to be browsed is determined according to the instruction; and

in specific implementation, the instruction input by the user on the webpage list can be understood as an instruction that is input by the user via a touch screen or a keyboard and other components of the mobile terminal based on the webpage list displayed on the display interface of the mobile terminal.

S104: the webpage address of the webpage to be browsed is sent to the intelligent terminal, thus allowing the intelligent terminal to display the webpage to be browsed corresponding to the webpage address of the webpage to be browsed.

In the step, after obtaining the webpage to be browsed, the intelligent terminal can directly invoke a browser interface in the intelligent terminal, a browser of the intelligent terminal loads the webpage to be browsed, and thus the webpage to be browsed is displayed on the display interface of the intelligent terminal.

In the embodiment, a non-transitory computer-readable storage medium storing executable instructions that, when executed by an electronic device with a touch-sensitive display, cause the electronic device to:

send a webpage list request to an intelligent terminal according to a link identifier, wherein the link identifier is generated based on the address of the intelligent terminal;

receive and display a webpage list corresponding to the webpage list request sent by the intelligent terminal;

detect an instruction input by a user on the webpage list and determining a webpage address of a webpage to be browsed according to the instruction; and

send the webpage address of the webpage to be browsed to the intelligent terminal, and allow the intelligent terminal to display the webpage to be browsed corresponding to the webpage address of the webpage to be browsed.

In the embodiment, the mobile terminal sends the webpage list request to the intelligent terminal according to the link identifier, receives and displays the webpage list corresponding to the webpage list request sent by the intelligent terminal, detects the instruction input by the user on the webpage list, determines the webpage address of the webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

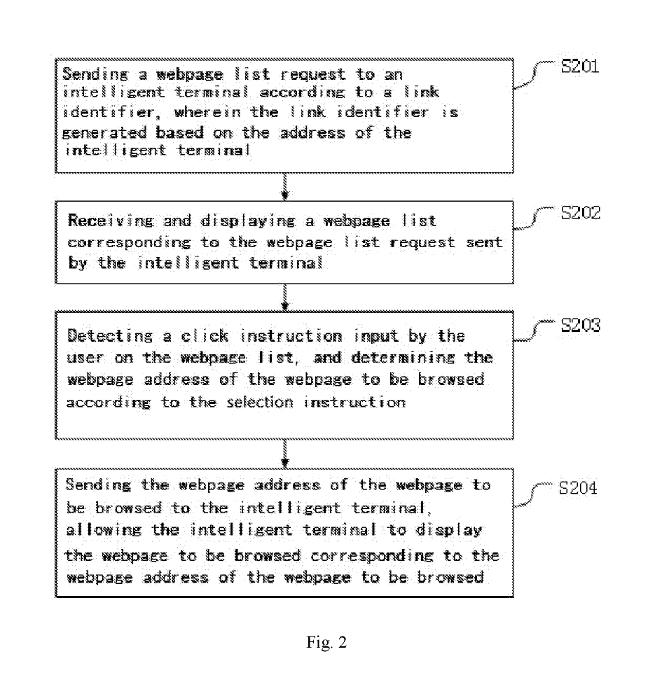

FIG. 2 is a flowchart of a webpage display method based on a link identifier provided by one embodiment of the present disclosure. Refer to FIG. 2, the method includes:

S201: a webpage list request is sent to an intelligent terminal according to a link identifier, wherein the link identifier is generated based on the address of the intelligent terminal;

S202: a webpage list corresponding to the webpage list request sent by the intelligent terminal is received and displayed; and

the steps S201 to S202 in the embodiment are the same as the steps S101 to S102 in the embodiment as shown in FIG. 1, and thus will not be repeated redundantly herein.

S203, a selection instruction input by the user on the webpage list is detected, and a webpage address of a webpage to be browsed is determined according to the selection instruction;

in specific implementation, the step can be understood as follows: since the webpage list is displayed on the display interface of the mobile terminal, if a touch screen is arranged on the display interface of the mobile terminal, the user can directly select a webpage address in the webpage list on the display interface so as to input the selection instruction, after detecting the selection instruction input by the user on the webpage list, the mobile terminal determines the corresponding webpage address according to the selection instruction, and uses the webpage address as the webpage address of the webpage to be browsed; and

if no touch screen is arranged on the display interface of the mobile terminal, the display interface of the mobile terminal will contain a cursor, the user can select the webpage address in the webpage list by the cursor according to the keyboard and other components so as to input the selection instruction, after detecting the selection instruction input by the user on the webpage list, the mobile terminal determines the corresponding webpage address according to the selection instruction, and uses the webpage address as the webpage address of the webpage to be browsed.

It can be understood that after determining the webpage address of the webpage to be browsed, the mobile terminal generally displays the webpage to be browsed on the display interface of the mobile terminal.

S204: the webpage address of the webpage to be browsed is sent to the intelligent terminal, thus allowing the intelligent terminal to display the webpage to be browsed corresponding to the webpage address of the webpage to be browsed.

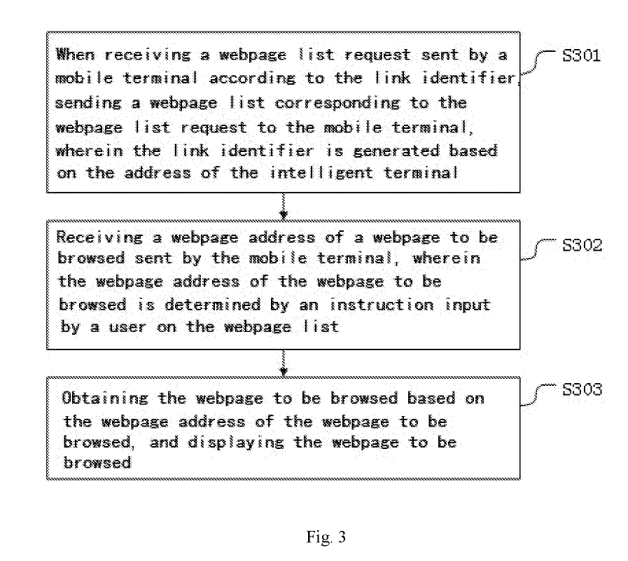

FIG. 3 is a flowchart of a webpage display method based on a link identifier provided by one embodiment of the present disclosure. Refer to FIG. 3, the method includes:

S301: when receiving a webpage list request sent by a mobile terminal according to the link identifier, a webpage list corresponding to the webpage list request is sent to the mobile terminal, wherein the link identifier is generated based on the address of the intelligent terminal; and

it can be understood that an executive body of the method in the embodiment is the intelligent terminal, the intelligent terminal is a smart TV and other terminal devices with similar functions, and this is not limited in the embodiment of the present disclosure.

In specific implementation, the link identifier can be a QR code, a barcode and other identifiers displayed on a display interface of the intelligent terminal, so the link identifier can be stored in the intelligent terminal, and furthermore, for the consideration of the space utilization rate and other requirements during the display on the display interface of the intelligent terminal, the link identifier is optionally the QR code.

The address of the intelligent terminal is an address that can be used for positioning the location of the intelligent terminal, for example, an IP address or an MAC address or the like, and this is not limited in the embodiment.

S302: a webpage address of a webpage to be browsed sent by the mobile terminal is received, wherein the webpage address of the webpage to be browsed is determined by an instruction input by a user on the webpage list; and

in specific implementation, the webpage list includes webpage addresses of a plurality of webpages, the webpage addresses are entry addresses linking the webpages, for example, a uniform resource locator (URL), an IP address or an MAC address or the like, and this is not limited in the embodiment.

To conveniently guide the operation of the user, the webpages in the webpage list are generally common webpages and can be collected in a network by a web crawler and other tools, for example, common video webpages and news webpages or the like, of course, the webpages of other types can also be included, and this is not limited in the embodiment.

S303: the webpage to be browsed is obtained based on the webpage address of the webpage to be browsed, and the webpage to be browsed is displayed.

In the step, after obtaining the webpage to be browsed, the intelligent terminal can directly invoke a browser interface in the intelligent terminal, a browser of the intelligent terminal loads the webpage to be browsed, and thus the webpage to be browsed is displayed on the display interface of the intelligent terminal.

In the embodiment, a non-transitory computer-readable storage medium storing executable instructions that, when executed by an electronic device with a touch-sensitive display, cause the electronic device to:

when receive a webpage list request sent by a mobile terminal according to the link identifier, sending a webpage list corresponding to the webpage list request to the mobile terminal, wherein the link identifier is generated based on the address of the intelligent terminal;

receive a webpage address of a webpage to be browsed sent by the mobile terminal, wherein the webpage address of the webpage to be browsed is determined by an instruction input by a user on the webpage list; and

obtain the webpage to be browsed based on the webpage address of the webpage to be browsed, and displaying the webpage to be browsed.

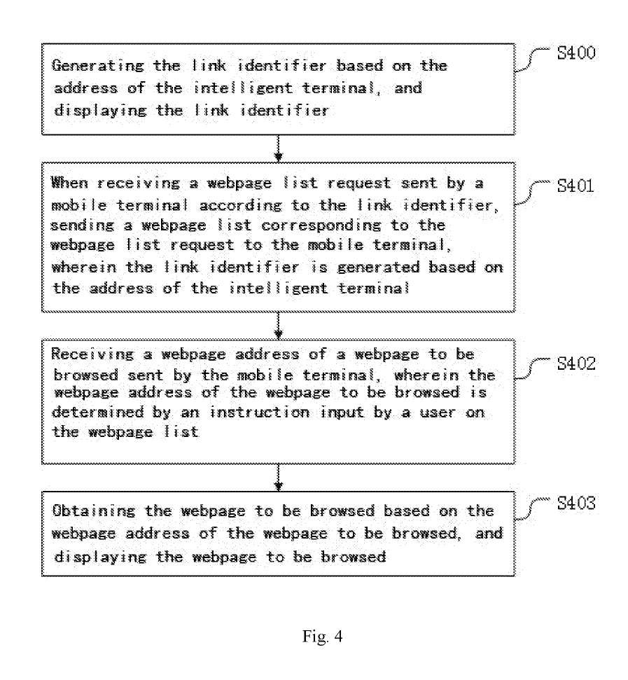

FIG. 4 is a flowchart of a webpage display method based on a link identifier provided by one embodiment of the present disclosure. Refer to FIG. 4, the method includes:

S400: the link identifier is generated based on the address of an intelligent terminal, and the link identifier is displayed; and

it can be understood that, to enable a user to conveniently see the link identifier, in the embodiment, after the link identifier is generated based on the address of the intelligent terminal, the link identifier is displayed, of course, the link identifier is generally displayed on a location that can be easily seen by the user on a display interface of the intelligent terminal, for example, the lower right corner of the display interface of the intelligent terminal.

S401: when receiving a webpage list request sent by a mobile terminal according to the link identifier, a webpage list corresponding to the webpage list request is sent to the mobile terminal, wherein the link identifier is generated based on the address of the intelligent terminal; and

the step S401 in the embodiment is the same as the step S301 in the embodiment as shown in FIG. 3, and thus will not be repeated redundantly herein.

S402: a webpage address of a webpage to be browsed sent by the mobile terminal is received, wherein the webpage address of the webpage to be browsed is determined by an instruction input by a user on the webpage list; and

in specific implementation, the communication between the intelligent terminal and the mobile terminal is generally a data packet based on HTTP, so the webpage address of the webpage to be browsed is generally sent by the data packet.

S403: the webpage to be browsed is obtained based on the webpage address of the webpage to be browsed, and the webpage to be browsed is displayed.

Since the data packet is a data packet based on HTTP, HTTP analysis can be carried out on the data packet, the HTTP analysis generally includes Header analysis and Body analysis, the Body analysis is divided into a PUT type and a POST type according to a request mode, the analysis process is a relatively mature technology, and thus will not be repeated redundantly herein.

For simple description, the method embodiments are expressed as a series of action combinations, but those skilled in the art should be aware that the embodiments of the present disclosure are not limited by the described action sequence, so according to the embodiments of the present disclosure, some steps can be carried out in other sequences or at the same time. Secondly, those skilled in the art should also be aware that the embodiments described in the description all belong to optional embodiments, and the involved actions are not essential to the embodiments of the present disclosure.

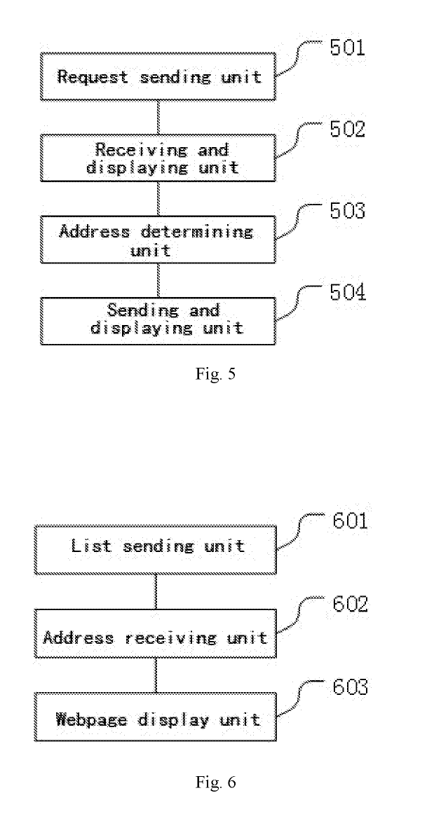

FIG. 5 is a structural block diagram of a mobile terminal provided by one embodiment of the present disclosure. Refer to FIG. 5, the mobile terminal includes:

a request sending unit 501, used for sending a webpage list request to an intelligent terminal according to a link identifier, wherein the link identifier is generated based on the address of the intelligent terminal;

a receiving and displaying unit 502, used for receiving and displaying a webpage list corresponding to the webpage list request sent by the intelligent terminal;

an address determining unit 503, used for detecting an instruction input by a user on the webpage list and determining a webpage address of a webpage to be browsed according to the instruction; and

a sending and displaying unit 504, used for sending the webpage address of the webpage to be browsed to the intelligent terminal, thus allowing the intelligent terminal to display the webpage to be browsed corresponding to the webpage address of the webpage to be browsed.

In an optional embodiment of the present disclosure, the address determining unit is further used for detecting a selection instruction input by the user on the webpage list, and determining the webpage address of the webpage to be browsed according to the selection instruction.

In an optional embodiment of the present disclosure, the request sending unit is further used for scanning the link identifier to send the webpage list request to the intelligent terminal, and the link identifier is a QR code.

FIG. 6 is a structural block diagram of an intelligent terminal provided by one embodiment of the present disclosure. Refer to FIG. 6, the intelligent terminal includes:

a list sending unit 601 used for, when receiving a webpage list request sent by a mobile terminal according to a link identifier, sending a webpage list corresponding to the webpage list request to the mobile terminal, wherein the link identifier is generated based on the address of the intelligent terminal;

an address receiving unit 602, used for receiving a webpage address of a webpage to be browsed sent by the mobile terminal, wherein the webpage address of the webpage to be browsed is determined by an instruction input by a user on the webpage list; and

a webpage display unit 603, used for obtaining the webpage to be browsed based on the webpage address of the webpage to be browsed and displaying the webpage to be browsed.

In an optional embodiment of the present disclosure, the intelligent terminal further includes:

an identifier generation unit, used for generating the link identifier based on the address of the intelligent terminal, and displaying the link identifier, wherein the link identifier is a QR code.

Another embodiment of the present disclosure further discloses a computer program, including a program code, wherein the program code is used for executing the following operations:

sending a webpage list request to an intelligent terminal according to a link identifier, wherein the link identifier is generated based on the address of the intelligent terminal;

receiving and displaying a webpage list corresponding to the webpage list request sent by the intelligent terminal;

detecting an instruction input by a user on the webpage list and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

Another embodiment of the present disclosure further discloses a storage medium, used for storing the above computer program.

The embodiment of the present disclosure further discloses an apparatus, including:

one or more processors;

a memory;

one or more program modules;

the one or more program modules are stored in the memory, and when being executed by the one or more processors, the one or more program modules execute the following operations:

sending a webpage list request to an intelligent terminal according to a link identifier, wherein the link identifier is generated based on the address of the intelligent terminal;

receiving and displaying a webpage list corresponding to the webpage list request sent by the intelligent terminal;

detecting an instruction input by a user on the webpage list and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

Another embodiment of the present disclosure further discloses a computer program, including a program code, wherein the program code is used for executing the following operations:

when receiving a webpage list request sent by a mobile terminal according to the link identifier, sending a webpage list corresponding to the webpage list request to the mobile terminal, wherein the link identifier is generated based on the address of the intelligent terminal;

receiving a webpage address of a webpage to be browsed sent by the mobile terminal, wherein the webpage address of the webpage to be browsed is determined by an instruction input by a user on the webpage list; and

obtaining the webpage to be browsed based on the webpage address of the webpage to be browsed, and displaying the webpage to be browsed.

Another embodiment of the present disclosure further discloses a storage medium, used for storing the above computer program.

The embodiment of the present disclosure further discloses an apparatus, including:

one or more processors;

a memory;

one or more program modules;

the one or more program modules are stored in the memory, and when being executed by the one or more processors, the one or more program modules execute the following operations:

when receiving a webpage list request sent by a mobile terminal according to the link identifier, sending a webpage list corresponding to the webpage list request to the mobile terminal, wherein the link identifier is generated based on the address of the intelligent terminal;

receiving a webpage address of a webpage to be browsed sent by the mobile terminal, wherein the webpage address of the webpage to be browsed is determined by an instruction input by a user on the webpage list; and

obtaining the webpage to be browsed based on the webpage address of the webpage to be browsed, and displaying the webpage to be browsed.

In summary, according to the webpage display method based on the link identifier, the mobile terminal, the intelligent terminal, the computer program, the storage medium and the apparatus provided by the embodiments of the present disclosure, the mobile terminal sends the webpage list request to the intelligent terminal according to the link identifier, receives and displays the webpage list corresponding to the webpage list request sent by the intelligent terminal, detects the instruction input by the user on the webpage list, determines the webpage address of the webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

The apparatus embodiments described above are merely exemplary, wherein units described as separate components can be separated physically or not, components displayed as units can be physical units or not, namely, can be located in one place, or can be distributed on a plurality of network units. A part of or all modules can be selected according to actual demand to achieve the objects of the solutions in the embodiments. Those of ordinary skill in the art can understand and implement the objects without any creative effort.

Those of ordinary skill in the art can understand that all or a part of the steps in the above method embodiment can be implemented by a program instructing corresponding hardware, the foregoing program can be stored in a computer readable storage medium, and when being executed, the program can execute the steps including the above method embodiment; and the foregoing storage medium includes various media capable of storing program codes, such as a ROM, a RAM, a magnetic disk or an optical disk, etc.

Finally, it should be noted that the above-mentioned embodiments are merely used for illustrating the technical solutions of the embodiments of the present disclosure, rather than limiting them; although the embodiments of the present disclosure have been described in detail with reference to the foregoing embodiments, those of ordinary skill in the art should understand that they could still make modifications to the technical solutions recorded in the foregoing embodiments or make equivalent substitutions to a part of or all technical features therein; and these modifications or substitutions do not make the essence of the corresponding technical solutions depart from the scope of the technical solutions of the embodiments of the present disclosure.

What is claimed is:

1. A webpage display method based on a link identifier, comprising:
sending a webpage list request to an intelligent terminal according to a link identifier, wherein the link identifier is generated based on the address of the intelligent terminal;
receiving and displaying a webpage list corresponding to the webpage list request sent by the intelligent terminal;
detecting an instruction input by a user on the webpage list and determining a webpage address of a webpage to be browsed according to the instruction; and
sending the webpage address of the webpage to be browsed to the intelligent terminal, allowing the intelligent terminal to display the webpage to be browsed corresponding to the webpage address of the webpage to be browsed.

2. The method of claim 1, wherein the detecting an instruction input by a user on the webpage list and determining the webpage address of a webpage to be browsed according to the instruction further comprises:
detecting a selection instruction input by the user on the webpage list, and determining the webpage address of the webpage to be browsed according to the selection instruction.

3. The method of claim 1, wherein the sending a webpage list request to an intelligent terminal according to a link identifier further comprises:
scanning the link identifier to send the webpage list request to the intelligent terminal, and the link identifier is a QR code.

4. A non-transitory computer-readable storage medium storing executable instructions that, when executed by an electronic device with a touch-sensitive display, cause the electronic device to:
send a webpage list request to an intelligent terminal according to a link identifier, wherein the link identifier is generated based on the address of the intelligent terminal;
receive and display a webpage list corresponding to the webpage list request sent by the intelligent terminal;
detect an instruction input by a user on the webpage list and determining a webpage address of a webpage to be browsed according to the instruction; and
send the webpage address of the webpage to be browsed to the intelligent terminal, and allow the intelligent terminal to display the webpage to be browsed corresponding to the webpage address of the webpage to be browsed.

5. The non-transitory computer-readable storage medium of claim 4, wherein detecte an instruction input by a user on the webpage list and determining the webpage address of a webpage to be browsed according to the instruction further comprises:
detect a selection instruction input by the user on the webpage list, and determining the webpage address of the webpage to be browsed according to the selection instruction.

6. The non-transitory computer-readable storage medium of claim 4, wherein send a webpage list request to an intelligent terminal according to a link identifier further comprises:
scan the link identifier to send the webpage list request to the intelligent terminal, and the link identifier is a QR code.

7. A webpage display method based on a link identifier, comprising:
when receiving a webpage list request sent by a mobile terminal according to the link identifier, sending a webpage list corresponding to the webpage list request to the mobile terminal, wherein the link identifier is generated based on the address of the intelligent terminal;
receiving a webpage address of a webpage to be browsed sent by the mobile terminal, wherein the webpage address of the webpage to be browsed is determined by an instruction input by a user on the webpage list; and
obtaining the webpage to be browsed based on the webpage address of the webpage to be browsed, and displaying the webpage to be browsed.

8. The method of claim 7, wherein when receiving a webpage list request sent by a mobile terminal according to the link identifier, before sending a webpage list corresponding to the webpage list request to the mobile terminal, the method further comprises:
generating the link identifier based on the address of the intelligent terminal, and displaying the link identifier, wherein the link identifier is a QR code.

9. A non-transitory computer-readable storage medium storing executable instructions that, when executed by an electronic device with a touch-sensitive display, cause the electronic device to:
when receive a webpage list request sent by a mobile terminal according to the link identifier, sending a webpage list corresponding to the webpage list request to the mobile terminal, wherein the link identifier is generated based on the address of the intelligent terminal;
receive a webpage address of a webpage to be browsed sent by the mobile terminal, wherein the webpage address of the webpage to be browsed is determined by an instruction input by a user on the webpage list; and
obtain the webpage to be browsed based on the webpage address of the webpage to be browsed, and displaying the webpage to be browsed.

10. The non-transitory computer-readable storage medium of claim 9, wherein when receive a webpage list request sent by a mobile terminal according to the link identifier, before send a webpage list corresponding to the webpage list request to the mobile terminal further comprises:
generate the link identifier based on the address of the intelligent terminal, and display the link identifier, wherein the link identifier is a QR code.
